(19) United States
(12) Patent Application Publication
(10) Pub. No.: US 2020/0072693 A1
(43) Pub. Date: Mar. 5, 2020

(54) HYDRAULIC GAGE CONTROL CYLINDER ANTI-DEADHEAD DEVICE

(71) Applicant: PRIMETALS TECHNOLOGIES USA LLC, ALPHARETTA, GA (US)

(72) Inventors: Ronald Claus, Medina, OH (US); Kenneth Scheffler, Dudley, MA (US); Peter Osgood, Westborough, MA (US); Thomas Wojtkowski, Sutton, MA (US); Ian Ward, Melrose, MA (US)

(73) Assignee: PRIMETALS TECHNOLOGIES USA LLC, ALPHARETTA, GA (US)

(21) Appl. No.: 16/114,700

(22) Filed: Aug. 28, 2018

(51) Int. Cl. G01L 19/06; G01L 7/16; G01L 19/14

(52) U.S. Cl. CPC G01L 19/0618; G01L 19/0609; F15B 21/00; G01L 19/145; G01L 7/16

(57) ABSTRACT

A hydraulic gage system is provided that includes a cylinder structure that is configured to allow the movement of a piston structure. The cylinder structure includes a plurality of vent structures that allows for the releasing of hydraulic fluid. A cover is positioned on the cylinder structure so when the piston passes the vent structures it relieves pressure as well as diminishes the force of impact on the cover by the piston.

### BACKGROUND OF THE INVENTION

The invention is related to the field of hydraulic systems, and in particular to a hydraulic gauge control anti-deadhead device to prevent damage by a piston.

A typical hydraulic gage control cylinder (HGC) can exert large amounts of force. If the piston travels to the end of its travel, it hits the cover, this is known as deadheading. Ideally, this should never happen, however it occasionally does. The cover is bolted to the cylinder, so if the piston contacts the cover when under full pressure, the cover and bolts that hold it must be strong enough to resist the force without breaking, deforming, or leaking. This is generally the limiting case for cylinder design. HGC cylinders are generally designed with very large bolts holding the cover to the cylinder and very thick covers to be able to withstand deadheading. At times deadheading is addressed by the control system, but this can fail. There have also been poppet type designs that relieve pressure when the piston gets close to the cover, but these can be complicated.

### SUMMARY OF THE INVENTION

According to one aspect of the invention, there is provided a hydraulic gage system. The hydraulic gage system includes a cylinder structure that is configured to allow the movement of a piston structure. The cylinder structure includes a plurality of vent structures that allows for the releasing of hydraulic fluid. A cover is positioned on the cylinder structure so when the piston passes the vent structures it relieves pressure as well as diminishes the force of impact on the cover by the piston.

According to another aspect of the invention, there is provided a method of forming a hydraulic gage system. The method includes configuring a cylinder structure so as to allow the movement of a piston structure. The cylinder structure includes a plurality of vent structures that allows for the releasing of hydraulic fluid. Also, the method includes positioning a cover on the cylinder structure so when the piston passes the vent structures it relieves pressure as well as diminishes the force of impact on the cover by the piston.

According to another aspect of the invention, there is provided a method of performing operations of a hydraulic gage. The method includes using a cylinder structure to control the movement of a piston structure. The cylinder structure includes a plurality of vent structures that allows for the releasing of hydraulic fluid. Also, the method includes providing a cover that is positioned on the cylinder structure so when the piston passes the vent structures it relieves pressure as well as diminishes the force of impact on the cover by the piston.

### BRIEF DESCRIPTION OF THE DRAWINGS

FIGS. 1A-1B are schematic diagrams illustrating a novel hydraulic gage control (HGC) cylinder used in accordance with the invention;

FIG. 2 is a schematic diagram illustrating a view of the cylinder used in accordance with the invention; and

FIG. 3 is schematic diagram illustrating the operations of the vent grooves used in accordance with the invention; and

### DETAILED DESCRIPTION OF THE INVENTION

The invention describes a novel hydraulic gage control (HGC) cylinder that relieves pressure when a piston near a cover. The inventive hydraulic gage control cylinder is composed of pressure relief grooves in the cylinder to relieve cylinder pressure when the piston nears the cover.

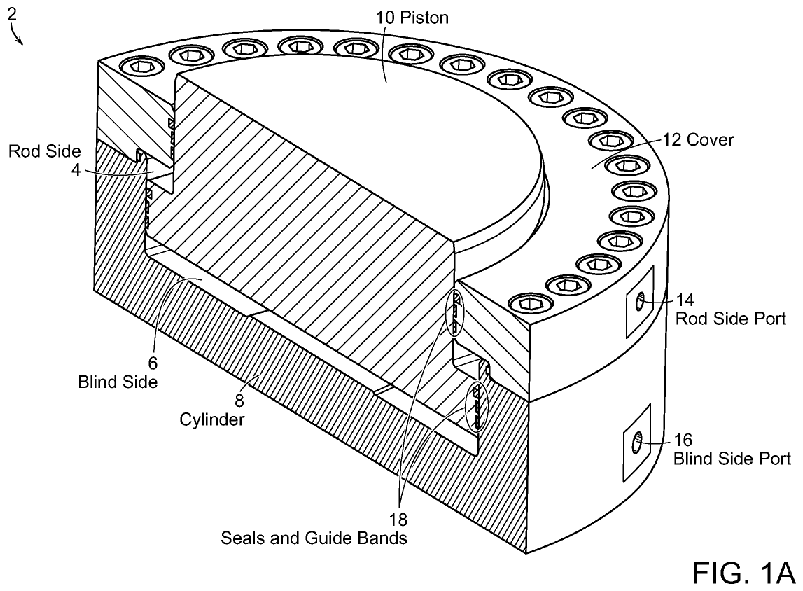

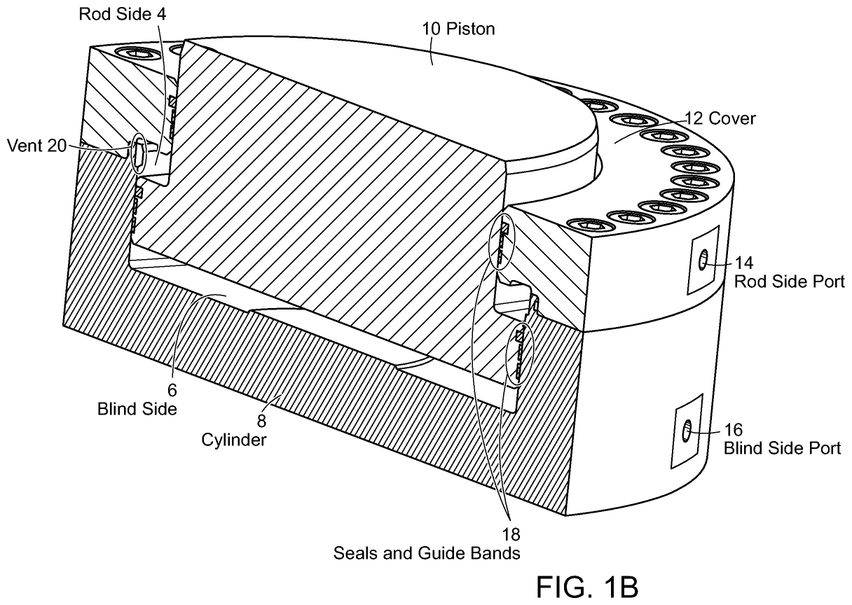

FIG. 1A is a schematic diagram illustrating a HGC cylinder 2. The HGC 2 cylinder include 3 major components: cylinder 8, piston 10, and cover 12. There are other components such as seal and guide bands 18, and bolts. HGC cylinders are generally designed with very large bolts holding the cover to the cylinder and very thick covers to be able to withstand deadheading. At times deadheading is addressed by the control system, but this can fail. There have also been poppet type designs that relieve pressure when the piston gets close to the cover, but these can be complicated. Two hydraulic chambers are formed: the “Blind Side” 6 and the “Rod Side” 4. They are each fed by different ports 14 and 16 to enable the cylinder 8 to be moved in two directions. The Blind Side 6 has a much larger surface area, so the piston 10 pushes much harder in the upwards direction. In the case of the piston 10 hitting the cover 12 at full force, both the cover 12 and cover bolts must be strong enough to not fail, deform, or leak.

The invention maintains the typical HGC cylinder's features and adds another. FIG. 1B shows the novel HGC cylinder 2 having a number of vents. The vents are used to relieve the pressure in the Blind Side 6 and Rod Side 4 via the Blind Side Port 16 and Rod Side Port 14.

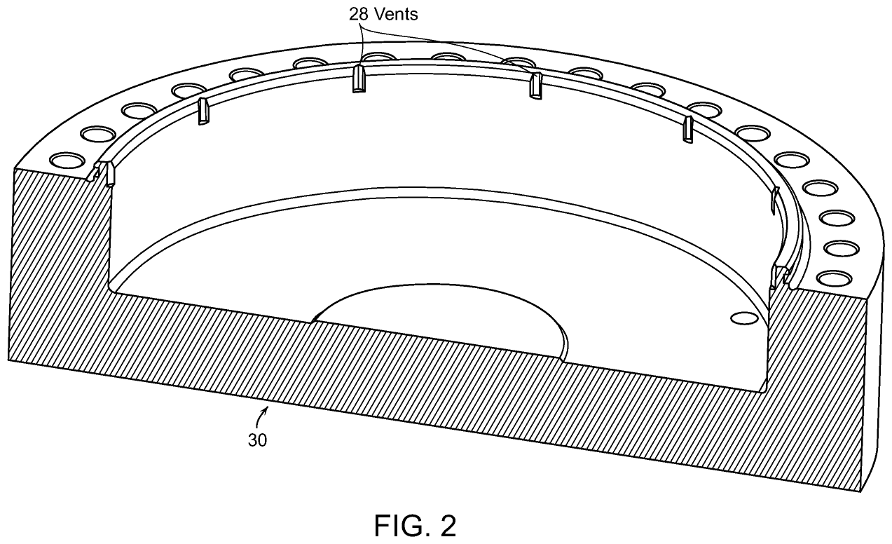

FIG. 2 shows a view of the cylinder 30 used in accordance with the invention. Around the top of the cylinder 30 are 12 equally spaced vent grooves 28. The number and size of the vent grooves 28 are calculated based on flow. The length of these vent grooves 28 is set so the piston seal is completely over the vent groove before the piston hits the cover. This lets the hydraulic fluid escape from the Blind Side or the Rod Side of the piston and relieve the pressure before the piston can exert any force on the cover. A typical cylinder does not have the vent grooves 28.

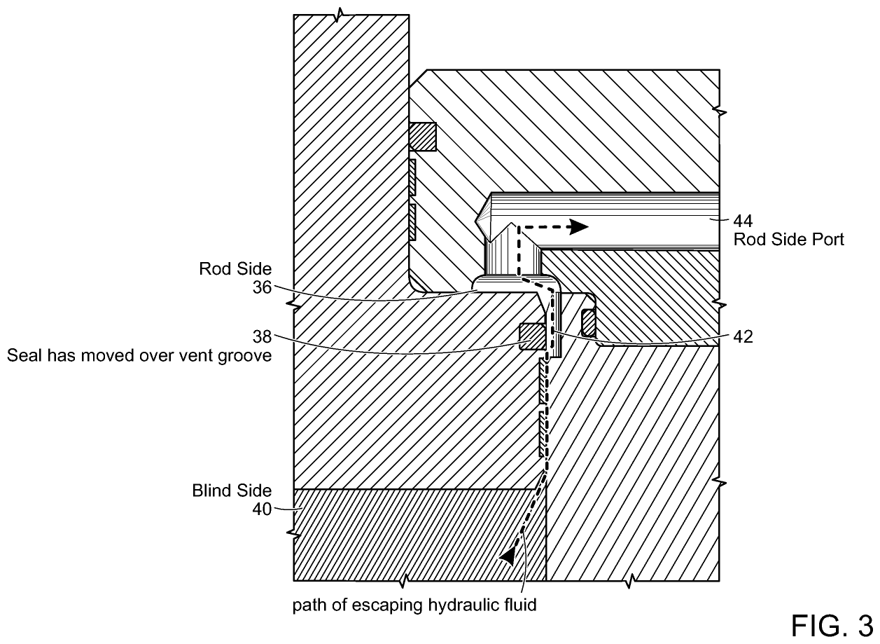

FIG. 3 is schematic diagram illustrating the operations of the vent grooves used in accordance with the invention. In particular, this figure illustrates the region defined by the vent grooves where the piston seal 38 has traveled over the vent groove 42 and the path of the hydraulic fluid escaping from the Blind Side 40 and relieving pressure via the Rod side 36. The hydraulic fluid leaves the HGC cylinder via the Rod Side port 44. Using vent grooves allow for a smaller cover, smaller and fewer cover bolts, and thinner piston. This approach allows the novel HGC cylinder to be smaller and less expensive.

As described herein, The invention provides a novel hydraulic gage control (HGC) cylinder that relieves pressure when a piston is near a cover to prevent deadheading. The use of vent grooves positioned on key locations on a HGC's cylinder aids in diminishing the cylinder pressure when the piston is near the cover. The vent grooves allow designers the freedom to incorporate smaller covers, s fewer cover bolts, and thinner pistons in designing hydraulic systems without incorporating substantial changes to the overall hydraulic cylinder gauge.

Although the present invention has been shown and described with respect to several preferred embodiments thereof, various changes, omissions and additions to the form and detail thereof, may be made therein, without departing from the spirit and scope of the invention.

What is claimed is:

1. A hydraulic gage system comprising:
a cylinder structure that is configured to allow the movement of a piston structure;
wherein the cylinder structure includes a plurality of vent structures that allows for the releasing of hydraulic fluid; and
a cover that is positioned on the cylinder structure so when the piston passes the vent structures it relieves pressure as well as diminishes the force of impact on the cover by the piston.

2. The hydraulic gage system of claim 1, wherein the cylinder structure comprises a blind side port to release hydraulic fluids via vent structures.

3. The hydraulic gage system of claim 1, wherein the cover comprises a rod side port to release hydraulic fluids via the vent structures.

4. The hydraulic gage system of claim 1, wherein the cover comprises a plurality of bolts positions for structural support.

5. The hydraulic gage system of claim 1, wherein the cylinder structure comprises one or more seals and guide bands.

6. The hydraulic gage system of claim 1, wherein the cover comprises one or more seals and guide bands.

7. The hydraulic gage system of claim 1, the size of the vent grooves are calculated based on flow.

8. The hydraulic gage system of claim 7, wherein the length of these vent structures are is set so the piston is completely over the vent structure before the piston reaches the cover.

9. A method of forming a hydraulic gage system comprising:
configuring a cylinder structure so as to allow the movement of a piston structure; wherein the cylinder structure includes a plurality of vent structures that allows for the releasing of hydraulic fluid; and
positioning a cover on the cylinder structure so when the piston passes the vent structures it relieves pressure as well as diminishes the force of impact on the cover by the piston.

10. The method of claim 9, wherein the cylinder structure comprises a blind side port to release hydraulic fluids via vent structures.

11. The method of claim 9, wherein the cover comprises a rod side port to release hydraulic fluids via the vent structures.

12. The method of claim 9, wherein the cover comprises a plurality of bolts positions for structural support.

13. The method of claim 9, wherein the cylinder structure comprises one or more seals and guide bands.

14. The method of claim 9, wherein the cover comprises one or more seals and guide bands.

15. The method of claim 9, the size of the vent grooves are calculated based on flow.

16. The method of claim 15, wherein the length of these vent structures are is set so the piston is completely over the vent structure before the piston reaches the cover.

17. A method of performing operations of a hydraulic gage comprising:
using a cylinder structure to control the movement of a piston structure; wherein the cylinder structure includes a plurality of vent structures that allows for the releasing of hydraulic fluid; and
providing a cover that is positioned on the cylinder structure so when the piston passes the vent structures it relieves pressure as well as diminishes the force of impact on the cover by the piston.

18. The method of claim 17, wherein the cylinder structure comprises a blind side port to release hydraulic fluids via vent structures.

19. The method of claim 17, wherein the cover comprises a rod side port to release hydraulic fluids via the vent structures.

20. The method of claim 17, wherein the cover comprises a plurality of bolts positions for structural support.

21. The method of claim 17, wherein the cylinder structure comprises one or more seals and guide bands.

22. The method of claim 17, wherein the cover comprises one or more seals and guide bands.

23. The method of claim 17, the size of the vent grooves are calculated based on flow.

24. The method of claim 23, wherein the length of these vent structures are is set so the piston is completely over the vent structure before the piston reaches the cover.
